(19) United States
(12) Patent Application Publication
(10) Pub. No.: US 2020/0070349 A1
(43) Pub. Date: Mar. 5, 2020

(54) ROBOT AND METHOD OF ADJUSTING ORIGINAL POSITION OF ROBOT

(71) Applicants: KAWASAKI JUKOGYO KABUSHIKI KAISHA, Kobe-shi (JP); KAWASAKI ROBOTICS (USA), INC., Wixom, MI (US)

(72) Inventors: Tetsuya YOSHIDA, Kakogawa-shi (JP); Hajime NAKAHARA, San Jose, CA (US); Ming ZENG, San Jose, CA (US)

(73) Assignees: KAWASAKI JUKOGYO KABUSHIKI KAISHA, Kobe-shi (JP); KAWASAKI ROBOTICS (USA), INC., Wixom, MI (US)

(21) Appl. No.: 16/119,634

(22) Filed: Aug. 31, 2018

(51) Int. Cl. B25J 9/16

(52) U.S. Cl. CPC B25J 9/1692; B25J 9/1612; B25J 9/1697; B25J 9/1664

(57) ABSTRACT

Provided is a robot which automatically adjusts an original position without requiring attachment and detachment of a jig or a sensor dedicated to adjustment of the original position. The robot includes a robot arm having a plurality of links connected via a joint, an end effector coupled to a distal end of the robot arm via a wrist joint, an imaging device attached to the end effector or the robot arm so that a whole of the end effector and the robot arm in the original posture is included in the imaging range, and a controller that controls operations of the robot arm and the imaging device. The controller sets rotational positions of a joint and a wrist joint as the original position, causes the imaging device to capture an image to acquire the captured image, obtains a deviation of a current posture of the end effector and the robot arm from the original posture by comparing the original posture reference image with the captured image, and determines presence or absence of displacement of the original position based on the deviation.

### BACKGROUND OF THE INVENTION

### (1) Field of the Invention

The present invention relates to a robot having a plurality of joints and a method of adjusting an original position of the robot.

### (2) Description of Related Art

Generally, an industrial robot includes a robot arm having a plurality of links connected via joints, an end effector coupled to a distal end of the robot arm via a joint, a base that supports the robot arm, and a controller that controls operations of the robot arm and the end effector.

The robot as described above has a predetermined original posture, and the rotational position in the original posture of each joint is set as the original position (that is, 0 deg.). However, when the robot arm or the end effector collides with another object, or the robot is used for many years, the axis of the joint is displaced, and even if each joint is returned to its original position, the robot may not return to the original posture. In such a case, it is necessary to adjust the original position of each joint.

As an example of the method of adjusting the original position, for example, a method is known in which a jig dedicated to adjustment of the original position disclosed in JP 1996-155866 A is used. In this method, the robot arm and the end effector are fixed to the original posture by using a jig, and the rotational position of each joint in that state is stored as the original position.

Further, as an example of the method of adjusting the original position, for example, a method is known in which a non-contact type sensor disclosed in JP 1996-090464 A is used. In this method, a light source is provided on the base, a light receiver is provided in the arm, and a posture where the light beam radiated from the light source can be detected by the light receiver is set as the original posture. The positional displacement and the positional displacement amount of the rotational position of the arm (joint) from a preset original position set in advance when the robot is in the original posture are calculated, and the original position of the arm is calibrated based on the calculation.
[Patent Literature 1] JP 1996-155866 A
[Patent Literature 2] JP 1996-090464 A

### SUMMARY OF THE INVENTION

For example, when adjusting an original position of a robot working in a sealed housing like a substrate transport robot, in the case of using a jig or a sensor dedicated to adjustment of the original position as described in JP 1996-155866 A and JP 1996-090464 A, the housing must be opened in order to attach and detach the jig and the sensor. Also, when an operator contacts the robot to attach and detach the jig or the sensor, the contacted part is contaminated. In particular, in a robot whose contamination should be avoided, such as a substrate transport robot or a medical work robot, decontamination after adjustment of the original position is complicated.

The present invention has been made in view of the above circumstances, and an object of the present invention is to provide a robot that automatically adjusts the original position without requiring attachment and detachment of a jig or a sensor dedicated to adjustment of the original position.

A robot according to an aspect of the present invention includes a robot arm having a plurality of links connected via a joint, an end effector coupled to a distal end of the robot arm via a wrist joint, an imaging device attached to the end effector or the robot arm so that rotational positions of the joint and the wrist joint when the end effector and the robot arm are in a predetermined original posture are set as an original position, and a whole of the end effector and the robot arm in the original posture is included in an imaging range, and a controller that controls operations of the robot arm and the imaging device. The controller sets the rotational positions of the joint and the wrist joint as the original position, causes the imaging device to capture an image to acquire the captured image, obtains a deviation of a current posture of the end effector and the robot arm from the original posture by comparing an original posture reference image representing the end effector and the robot arm in the original posture with the captured image, and determines presence or absence of displacement of the original position based on the deviation.

In a method of adjusting an original position of a robot according to an aspect of the present invention, the robot includes a robot arm having a plurality of links connected via a joint, an end effector coupled to a distal end of the robot arm via a wrist joint, and an imaging device attached to the end effector or the robot arm so that rotational positions of the joint and the wrist joint when the end effector and the robot arm are in a predetermined original posture are set as an original position, and the end effector and the robot arm in the original posture is included in an imaging range. The method includes setting the rotational positions of the joint and the wrist joint as the original position, causing the imaging device to capture an image to acquire the captured image, obtaining a deviation of a current posture of the end effector and the robot arm from the original posture by comparing an original posture reference image representing the end effector and the robot arm in the original posture with the captured image, and determining presence or absence of displacement of the original position based on the deviation.

In the above robot and the method of adjusting an original position of the robot, a deviation from the original posture of the current posture of the end effector and the robot arm is obtained using the captured image by the imaging device mounted on the robot itself. Therefore, it is not necessary to attach and detach a dedicated jig or a dedicated sensor when adjusting the original position, and it is unnecessary for an operator to contact the robot. Therefore, even in a robot installed in a sealed space, it is possible to adjust the original position (confirm the original position) at an arbitrary timing. Further, it is possible to automatically adjust the original position without intervention of the operator's hand.

According to the present invention, it is possible to automatically adjust the original position in the robot without requiring attachment and detachment of a jig or sensor dedicated to adjustment of the original position.

### BRIEF DESCRIPTION OF THE DRAWINGS

FIG. 1 is a diagram showing a schematic configuration of a robot according to an embodiment of the present invention;

FIG. 2 is a diagram showing a configuration of a control system of the robot shown in FIG. 1;

FIG. 3 is a diagram showing a configuration of a joint drive device;

FIG. 4 is a diagram showing an example of an original posture reference image; and

FIG. 5 is a flowchart of a process of adjusting the original position.

### DETAILED DESCRIPTION OF PREFERRED EMBODIMENTS

Embodiments of the present invention will be described in detail below with reference to the drawings. Here, the present invention applied to a substrate transport robot that transports a substrate in a clean space will be described. However, the robot to which the present invention is applied is not limited thereto, and the present invention can be widely applied to a robot including a robot arm having at least one joint including a horizontally articulated robot and a vertically articulated robot.

### [Configuration of Robot 7]

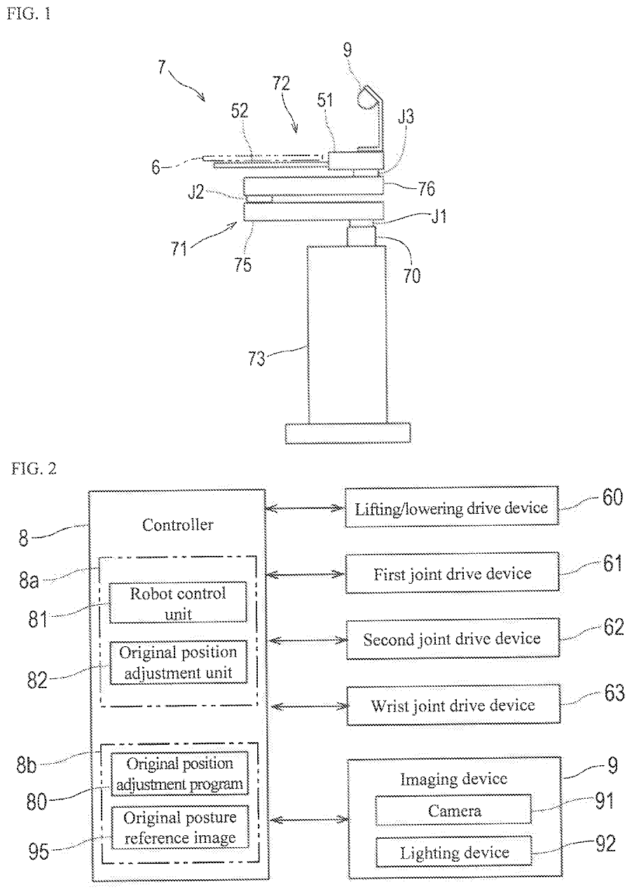

First, the configuration of a robot 7 according to the present embodiment will be described. FIG. 1 is a diagram showing a schematic configuration of the robot 7 according to this embodiment, and FIG. 2 is a diagram showing a configuration of a control system of the robot 7 shown in FIG. 1.

As shown in FIGS. 1 and 2, the robot 7 includes a robot arm (hereinafter simply referred to as an “arm 71”), a substrate holding hand as an end effector coupled to a wrist portion of the arm 71 (hereinafter simply referred to as a “hand 72”), a base 73 that supports the arm 71, an imaging device 9 attached to the arm 71 or the hand 72, and a controller 8.

The arm 71 has a plurality of links 70, 75, 76 connected via joints J1, J2. The plurality of links includes the lifting/lowering link 70 supported on a base 73 so as to be movable up and down, and at least one horizontal link 75, 76. In the arm 71 according to the present embodiment, a proximal end of the first link 75 is coupled to an upper end of the lifting/lowering link 70 via the first joint J1, and a proximal end of the second link 76 is coupled to a distal end of the first link 75 via the second joint J2. The proximal end of the hand 72 is coupled to the distal end of the second link 76 via a wrist joint J3. The first joint J1, the second joint J2, and the wrist joint J3 are joints that rotatably connect two elements around a vertical axis.

The hand 72 includes a hand proximal portion 51 coupled to the distal end of the arm 71 and a blade 52 connected to the hand proximal portion 51. The blade 52 is provided with a holding device (not shown) for holding the substrate 6. This holding device may prevent the substrate 6 placed on the blade 52 from being removed from the blade 52 by being engaged, sucked, clamped, or otherwise.

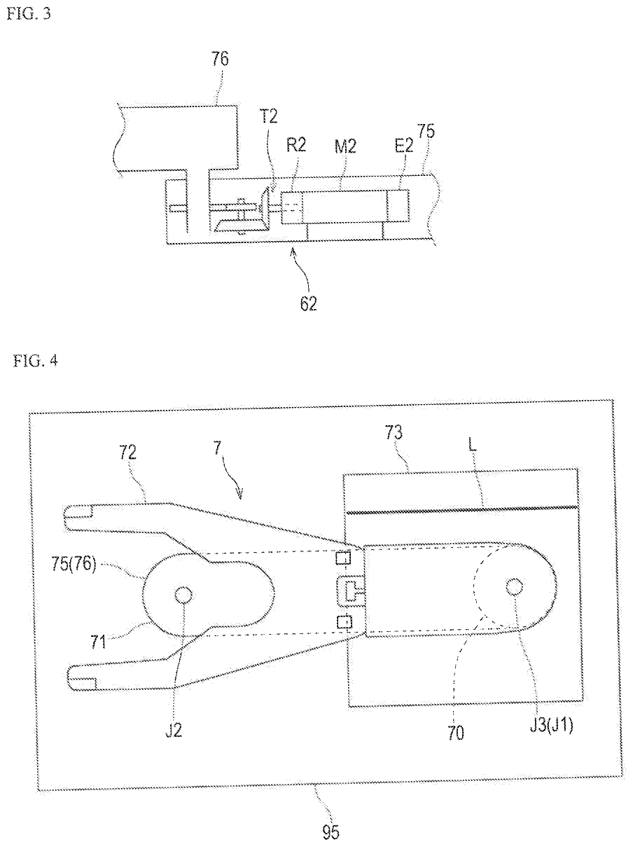

A first joint drive device 61 that drives the first joint J1 and a second joint drive device 62 that drives the second joint J2 are provided in the first link 75. A wrist joint drive device 63 that drives the wrist joint J3 is provided in the second link 76. The drive devices 61 to 63 of the respective joints J1 to J3 have substantially the same structure. That is, as shown in FIG. 3, the drive devices 61 to 63 of the joints J1 to J3 include servo motors M1 to M3 that are angularly displaced according to a signal given from the controller 8, power transmission mechanisms T1 to T3 that include deceleration devices R1 to R3, and that transmit power of the servo motors M1 to M3 to the links 75, 76 (or the hand 72), and position detectors E1 to E3 that detect angular displacements of the servo motors M1 to M3. FIG. 3 shows the drive device 62 as a representative of the drive devices 61 to 63. In the drive device 61, the numeral attached to M, R, T, and E in FIG. 3 is replaced with 1, and in the drive device 63, the numeral attached to M, R, T, and E in FIG. 3 is replaced with 3, so that the configuration of each of the drive devices 61 to 63 is shown.

Further, a lifting/lowering drive device 60 that lifts and lowers the lifting/lowering link 70 is provided in the base 73. The lifting/lowering drive device 60 includes, for example, a servo motor M0 that is angularly displaced in accordance with a signal given from the controller 8, a power transmission mechanism T0 that includes a deceleration device R0 and that converts the power of the servo motor into a straightforward force to transmit the straightforward force to the lifting/lowering link 70, and a position detector E0 that detects the angular displacement of the servo motor M0.

The imaging device 9 includes a camera 91 and a lighting device 92 that irradiates the imaging range of the camera 91 with light. The imaging device 9 is attached to the arm 71 or the hand 72 so that the whole of the arm 71 and the hand 72 in the original posture to be described later is included in the imaging range. In the present embodiment, the imaging device 9 is attached to the hand 72 via a stay so as not to interfere with the arm 71, the substrate 6 to be held, or the like, but the imaging device 9 may be attached to the arm 71. The imaging device 9 may be supported by a movable stay that displaces the imaging device 9 to a position where the whole of the arm 71 and the hand 72 in the original posture is included in the imaging range at the time of adjusting the original position to be described later.

The controller 8 controls the operations of the arm 71, the hand 72, and the imaging device 9. The controller 8 includes a robot control unit 81 and an original position adjustment unit 82. The controller 8 is a so-called computer, and includes, for example, a processor 8a such as a microcontroller, a CPU, an MPU, a PLC, a DSP, an ASIC or a FPGA, and a memory 8b such as a ROM and a RAM. The memory 8b stores a program which includes an original position adjustment program 80 and executed by the processor 8a. Data and the like used for processing performed by the processor 8a are stored in the memory 8b. In the controller 8, the processor 8a reads out and executes the program stored in the memory 8b, so that the processes for functioning as the robot control unit 81 and the original position adjustment unit 82 are performed. Note that the controller 8 may execute each process by centralized control by a single computer or each process may be executed by distributed control by cooperation of a plurality of computers.

The robot control unit 81 of the controller 8 controls the operation of the robot 7. More specifically, the robot control unit 81 is electrically connected to the lifting/lowering drive device 60, the first joint drive device 61, the second joint drive device 62, and the first wrist joint drive device 63. The robot control unit 81 acquires the rotational positions of the servo motors M0 to M3 from the position detectors E0 to E3 included in these drive devices 60 to 63, and calculates a target pose based on a pose of the hand 72 corresponding to the rotational positions (position and posture) and the stored teaching point data. Further, the robot control unit 81 outputs a control command to a servo amplifier so that the hand 72 takes the target pose. The servo amplifier supplies driving power to each of the servo motors M0 to M3 based on the control command, whereby the hand 72 moves to the target pose.

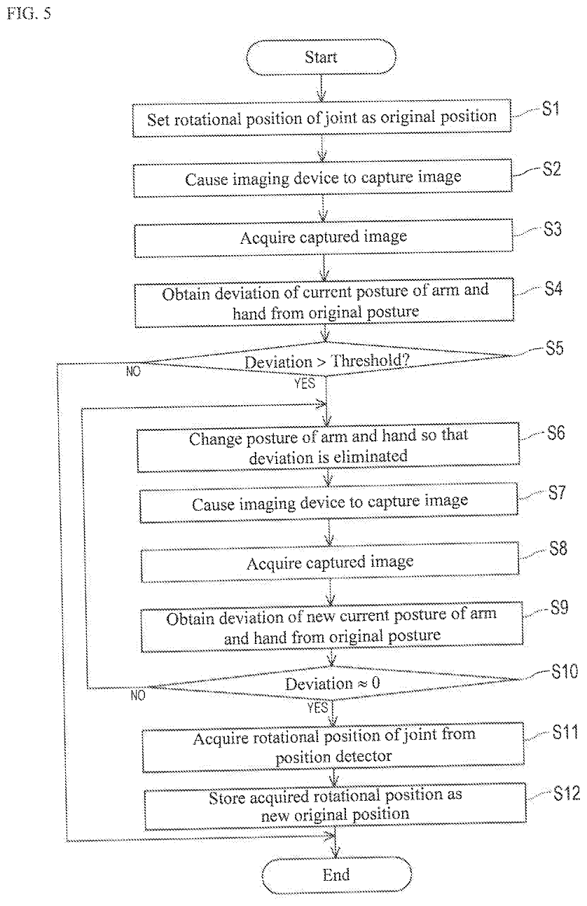

The original position adjustment unit 82 of the controller 8 adjusts the original position of the robot 7. The robot 7 has a predetermined original posture. FIG. 4 shows an original posture reference image 95 obtained by capturing an image of the arm 71 and the hand 72 of the robot 7 in the original posture with the imaging device 9. In FIG. 4, the stay supporting the imaging device 9 is omitted. As shown in FIG. 4, in the present embodiment, the original posture of the arm 71 and the hand 72 of the robot 7 is a posture in which (i) a predetermined horizontal original reference line L defined on the base 73, the longitudinal direction of the first link 75, the longitudinal direction of the second link 76, and the longitudinal direction of the hand 72 are parallel with one another, (ii) the first link 75, the second link 76, and the hand 72 overlap in plan view, and (iii) the rotation axis of the first joint J1 and the rotation axis of the third joint J3 are arranged on the same straight line. The original reference line L may be marked on the base 73 or a floor on which the base 73 is installed. However, the original posture of the robot 7 may be determined in any form.

When the arm 71 and the hand 72 of the robot 7 are in the original posture, for example, in a state in which no axis displacement, fatigue or the like has occurred in the respective joints J1 to J3 as in the factory shipment, the controller 8 causes the imaging device 9 to capture the image of the arm 71 and the hand 72, and stores the captured image as the original posture reference image 95. Note that the original posture reference image 95 may be a pseudo image which corresponds to an image obtained by capturing the arm 71 and the hand 72 in the original posture with the imaging device 9. In other words, the original posture reference image 95 is not limited to the image captured by the imaging device 9, but may be an image created by mimicking the image, an image representing the position of a featured point (for example, a contour), or the like.

When the arm 71 and the hand 72 of the robot 7 are in the original posture in a state in which no axis displacement, fatigue or the like has occurred in the respective joints J1 to J3, the controller 8 acquires the rotational positions of the respective joints J1 to J3 from the position detectors E1 to E3, and stores the acquired rotational positions as the original position (initial original position) of the respective joints J1 to J3.

As described above, when the joints J1 to J3 are at the original position, the arm 71 and the hand 72 of the robot 7 are adjusted so as to be in the original posture, but if the arm 71 and the hand 72 collide with the object, or are continuously used for a long period of time, axis displacement occurs to the joints J1 to J3, and even if the joints J1 to J3 are set as the original position, the arm 71 and the hand 72 may not be in the original posture. The original position adjustment unit 82 detects such displacement of the original position and adjusts the original position according to the degree of the displacement of the original position. Hereinafter, the method of adjusting the original position will be described with reference to FIG. 5.

### [Method of Adjusting Original Position]

The process of adjusting the original position includes a process related to the detection of the displacement of the original position and a process of adjusting the original position so as to eliminate the displacement of the original position when the displacement of the original position is detected. As shown in FIG. 5, the controller 8 which has started the process of adjusting the original position firstly operates the respective drive devices 61 to 63 so that the rotational positions of the joints J1 to J3 are at the original position (step S1). Next, the controller 8 causes the imaging device 9 to capture an image (step S2). The imaging range of the imaging device 9 includes the arm 71 and the hand 72 of the current posture.

The controller 8 acquires a captured image from the imaging device 9 (step S3), and obtains, by the image processing, the deviation of the current posture of the arm 71 and the hand 72 included in the captured image from the original posture of the arm 71 and the hand 72 included in the original posture reference image 95 (step S4). Here, for example, the controller 8 may compare the captured image with the original posture reference image 95 by a known image processing method, extract a difference between the captured image and the original posture reference image 95, and obtain a deviation of the current posture from the original posture based on the extracted difference. Further, for example, the controller 8 may extract, by image processing, the profile of the links 75, 76 and the hand 72 included in the captured image, and identify the longitudinal direction of the links 75, 76 and the hand 72 in the captured image. The inclination from the original reference line L in the captured image may be taken as the deviation of the current posture from the original posture. The deviation of the current posture from the original posture may be obtained for each link and the hand.

The controller 8 compares the obtained deviation with a previously stored threshold. When the deviation exceeds the threshold (YES in step S5), the controller 8 determines that the “displacement of the original position” is present. When the deviation is equal to or less than the threshold (NO in step S5), the controller 8 determines that the “displacement of the original position” is absent, and ends the process.

When the “displacement of the original position” is detected (YES in step S5), a process of adjusting the original position is subsequently performed. The controller 8 changes the posture of the arm 71 and the hand 72 by operating the drive devices 61 to 63 so as to eliminate the deviation based on the obtained deviation (step S6). The controller 8 causes the imaging device 9 to capture an image (step S7). The imaging range of the imaging device 9 includes the arm 71 and the hand 72 in a new current posture.

The controller 8 acquires the captured image (step S8) and obtains, by the image processing, the deviation of the new current posture of the arm 71 and the hand 72 included in the captured image from the original posture of the arm 71 and the hand 72 included in the original posture reference image 95 (step S9). The method of obtaining the deviation may be the same as the method of obtaining the deviation of the current posture from the original posture.

The controller 8 repeats the steps S6 to S9 until the deviation of the new current posture from the original posture is substantially zero (YES in step S10). Note that substantially zero may include zero and a sufficiently small value.

When the deviation of the new current posture from the original posture is substantially zero (YES in step S10), the controller 8 acquires the rotational positions of the joints J1 to J3 at that time from the position detectors E1 to E3 (step S11), stores the acquired rotational positions as a new original position (step S12), and ends the process.

As described above, the robot 7 of the present embodiment includes a robot arm 71 having the plurality of links 70, 75, 76 connected via joints J1, J2, an end effector 72 coupled to the distal end of the robot arm 71 via a wrist joint J3, an imaging device 9 attached to the end effector 72 or the robot arm 71, and a controller 8 that controls operations of the robot arm 71 and the imaging device 9. The rotational positions of the joints J1, J2 and the wrist joint J3 when the end effector 72 and the robot arm 71 are in the predetermined original posture are set as the original position. The imaging device 9 is attached to the end effector 72 or the robot arm 71 so that the whole of the end effector 72 and the robot arm 71 in the original posture are included in the imaging range.

The controller 8 includes the memory 8b that stores the original position adjustment program 80 and the original posture reference image 95, and the processor 8a that executes the original position adjustment program 80. The original position adjustment program causes the processor 8a to set the rotational positions of the joints J1, J2 and the wrist joint J3 as the original position, cause the imaging device 9 to capture an image to acquire the captured image, obtain the deviation of the current posture of the end effector 72 and the robot arm 71 from the original posture by comparing the original posture reference image 95 with the captured image, and determine the presence or absence of the displacement of the original position based on the deviation.

That is, the controller 8 sets the rotational positions of the joints J1, J2 and the wrist joint J3 as the original position, causes the imaging device 9 to capture an image to acquire the captured image, obtains the deviation of the current posture of the end effector 72 and the robot arm 71 from the original posture by comparing the original posture reference image 95 representing the end effector 72 and the robot arm 71 in the original posture with the captured image, and determines the presence or absence of the displacement of the original position based on the deviation.

Further, the method of adjusting the original position of the robot 7 according to the present embodiment includes: setting the rotational positions of the joints J1, J2 and the wrist joint J3 as the original position; capturing an image by the imaging device 9 to acquire the captured image; obtaining a deviation of a current posture of the end effector 72 and the robot arm 71 from the original posture by comparing the original posture reference image 95 representing the end effector 72 and the robot arm 71 in the original posture with the captured image, and determining presence or absence of the displacement of the original position based on the deviation.

According to the robot 7 and the method of adjusting the original position of the robot, the robot 7 uses the captured image by the imaging device 9 mounted on the robot 7 itself, and obtains a deviation of the current posture (that is, the original posture) of the end effector 72 and the robot arm 71 from the original posture. Therefore, when adjusting the original position, the robot 7 does not require attachment and detachment of a dedicated jig or a dedicated sensor, and the operator does not need to contact the robot 7. Therefore, even in the case of a robot 7 installed in a sealed space like a substrate transport robot, the original position adjustment (more specifically, confirm the original position) is not limited to be performed at the time of maintenance, and may be performed at any timing. Furthermore, it is possible to automatically confirm the original position without intervention of the operator's hand.

Further, as shown in the present embodiment, in the robot 7, the original position adjustment program 80 is configured, when the processor 8a determines that there is displacement of the original position, to cause the processor 8a to change the posture of the end effector 72 and the robot arm 71 so that the deviation is eliminated, cause the imaging device 9 to capture an image to acquire the captured image, repeat obtaining a deviation of a new current posture from the original posture until the deviation is substantially zero by comparing the captured image with the original posture reference image 95, and store the rotational positions of the joints J1, J2 and the wrist joint J3 when the deviation is substantially zero as a new original position.

That is, in the robot 7, when the controller 8 determines that displacement of the original position is present, the controller 8 may change the posture of the end effector 72 and the robot arm 71 so that the deviation is eliminated, may cause the imaging device 9 to capture an image to acquire the captured image, may repeat obtaining a deviation of a new current posture from the original posture until the deviation is substantially zero by comparing the captured image with the original posture reference image 95, and may store the rotational positions of the joints J1, J2 and the wrist joint J3 when the deviation is substantially zero as a new original position.

Similarly, the method of adjusting the original position of the robot may further include, when it is determined that displacement of the original position is present, changing the posture of the end effector 72 and the robot arm 71 so that the deviation is eliminated, causing the imaging device 9 to capture an image to acquire the captured image, repeating obtaining a deviation of a new current posture from the original posture until the deviation is substantially zero by comparing the captured image with the original posture reference image 95, and storing the rotational positions of the joints J1, J2 and the wrist joint J3 when the deviation is substantially zero as a new original position.

According to the robot 7 and the method of adjusting the original position of the robot, the robot 7 uses the captured image by the imaging device 9 mounted on the robot 7 itself to operate the joints J1, J2 and the wrist joint J3 such that the current posture of the end effector 72 and the robot arm 71 coincides with the original posture, and obtains a new original position (that is, the adjusted original position). As described above, when adjusting the original position, the robot 7 does not require attachment and detachment of a dedicated jig or a dedicated sensor, and the operator does not need to contact the robot. Therefore, even in the case of a robot 7 installed in a sealed space like a substrate transport robot, the original position adjustment is not limited to be performed at the time of maintenance, and may be performed at any timing. Furthermore, it is possible to automatically adjust the original position without intervention of the operator's hand.

Although the preferred embodiments of the present invention have been described above, it is also possible to include modifications of details of the specific structure and/or function of the above embodiment without departing from the spirit of the present invention.

### DESCRIPTION OF REFERENCE CHARACTERS

6: substrate
7: robot
8: controller
8a: processor
8b: memory
9: imaging device
51: hand proximal portion
52: blade
60-63: drive device
70,75,76: link
71: robot arm
72: end effector
73: base
80: original position adjustment program
81: robot control unit
82: original position adjustment unit
91: camera
92: lighting device
E0-E3: position detectors
J1-J3 joint
L: original reference line
M0-M3: servo motors
R0-R3: deceleration device (reducer)
T0-T3: power transmission mechanism

What is claimed is:

1. A robot comprising:
a robot arm having a plurality of links connected via a joint;
an end effector coupled to a distal end of the robot arm via a wrist joint;
an imaging device attached to the end effector or the robot arm so that rotational positions of the joint and the wrist joint when the end effector and the robot arm are in a predetermined original posture are set as an original position, and a whole of the end effector and the robot arm in the original posture is included in an imaging range; and
a controller that controls operations of the robot arm and the imaging device,
wherein the controller sets the rotational positions of the joint and the wrist joint as the original position, causes the imaging device to capture an image to acquire the captured image, obtains a deviation of a current posture of the end effector and the robot arm from the original posture by comparing an original posture reference image representing the end effector and the robot arm in the original posture with the captured image, and determines presence or absence of displacement of the original position based on the deviation.

2. The robot according to claim 1, wherein when the controller determines that the displacement of the original position is present, the controller repeats, until the deviation is substantially zero, changing a posture of the end effector and the robot arm so that the deviation is eliminated, causing the imaging device to capture an image to acquire the captured image, and obtaining a deviation of a new current posture from the original posture by comparing the captured image with the original posture reference image, and stores, as a new original position, rotational positions of the joint and the wrist joint when the deviation is substantially zero.

3. A method of adjusting an original position of a robot,
the robot including: a robot arm having a plurality of links connected via a joint; an end effector coupled to a distal end of the robot arm via a wrist joint; and an imaging device attached to the end effector or the robot arm so that rotational positions of the joint and the wrist joint when the end effector and the robot arm are in a predetermined original posture are set as an original position, and the end effector and the robot arm in the original posture is included in an imaging range,
the method comprising:
setting the rotational positions of the joint and the wrist joint as the original position;
causing the imaging device to capture an image to acquire the captured image;
obtaining a deviation of a current posture of the end effector and the robot arm from the original posture by comparing an original posture reference image representing the end effector and the robot arm in the original posture with the captured image; and
determining presence or absence of displacement of the original position based on the deviation.

4. The method of adjusting an original position of a robot according to claim 3, the method further comprising:
when it is determined that displacement of the original position is present, repeating, until the deviation is substantially zero, changing a posture of the end effector and the robot arm so that the deviation is eliminated, causing the imaging device to capture an image to acquire the captured image, and obtaining a deviation of a new current posture from the original posture by comparing the captured image with the original posture reference image; and
storing, as a new original position, rotational positions of the joint and the wrist joint when the deviation is substantially zero.
